(19) United States
(12) Patent Application Publication
(10) Pub. No.: US 2010/0296520 A1
(43) Pub. Date: Nov. 25, 2010

(54) DYNAMIC QUALITY OF SERVICE ADJUSTMENT ACROSS A SWITCHING FABRIC

(76) Inventors: David L. Matthews, Cypress, TX (US); Paul V. Brownell, Houston, TX (US); Darren T. Hoy, Cypress, TX (US); Hubert E. Brinkman, Spring, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/468,302

(22) Filed: May 19, 2009

(51) Int. Cl. H04J 3/22; G06F 15/173

(52) U.S. Cl. 370/468; 709/226

(57) ABSTRACT

In a shared I/O environment, a method for dynamic memory bandwidth adjustment adjusts memory bandwidth between a host server and an I/O function by increasing memory bandwidth to higher priority functions while decreasing memory bandwidth to lower priority functions without bringing down the link between the host and I/O devices.

### BACKGROUND

Blade servers are self-contained all inclusive computer servers, designed for high density. Blade servers have many components removed for space, power and other considerations while still having all the functional components to be considered a computer (i.e., memory, processor, storage).

The blade servers are housed in a blade enclosure. The enclosure can hold multiple blade servers and perform many of the non-core services (i.e., power, cooling, I/O, networking) found in most computers. By locating these services in one place and sharing them amongst the blade servers using a switch fabric, the overall component utilization is more efficient.

In a shared I/O environment, multiple servers may be sharing the same I/O device. It may be desirable to adjust the memory bandwidth to a particular host server to enable higher priority to a high memory bandwidth application while decreasing priority to another host server that is running a lower priority application. PCI Express (PCI-e) switches allow for such an adjustment but the management module brings down the link and resets/initializes the I/O device in order to accomplish the adjustment.

### BRIEF DESCRIPTION OF THE DRAWINGS

FIG. 1 depicts a block diagram of one embodiment of a server system.

FIG. 2 depicts a flow chart of one embodiment of a method for adding a new resource to the server system of FIG. 1.

FIG. 3 depicts a flow chart of one embodiment of a method for adding memory bandwidth to a resource.

FIG. 4 depicts a flow chart of one embodiment of a method for reducing memory bandwidth to a resource.

### DETAILED DESCRIPTION

The following detailed description is not to be taken in a limiting sense. Other embodiments may be utilized and changes may be made without departing from the scope of the present disclosure.

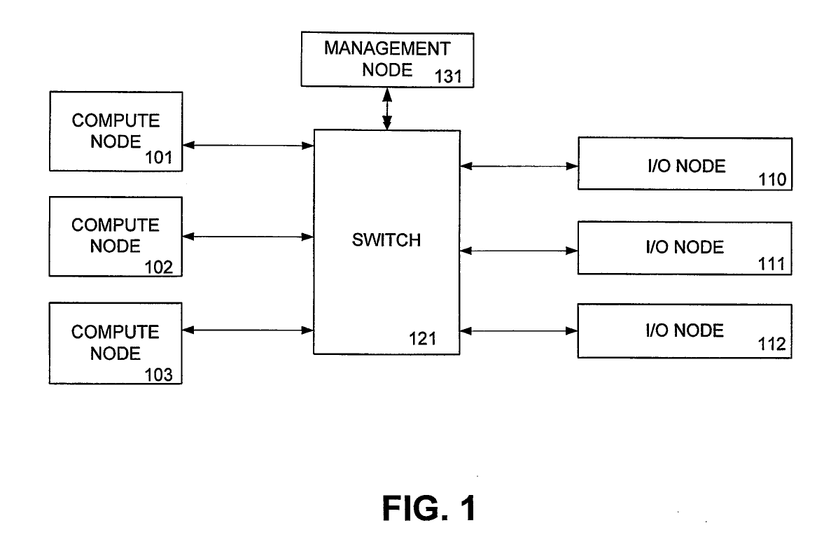

FIG. 1 illustrates a block diagram of one embodiment of a server system that can incorporate the virtual hot plugging functions of the present embodiments. The illustrated embodiment has been simplified to better illustrate the operation of the virtual hot plugging functions. Alternate embodiments may use other functional blocks in which the virtual hot plugging functions can operate.

The system is comprised of a plurality of compute nodes 101-103. In one embodiment, the compute nodes 101-103 can be host blade servers also referred to as host nodes. The host nodes may be comprised of any components typically used in a computer system such as a processor, memory, and storage devices.

The system is further comprised of I/O platforms 110-112 also referred to as I/O nodes. The I/O nodes 110-112 can be typical I/O devices that are used in a computer server system. Such I/O nodes can include serial and parallel I/O, fiber I/O, and switches (e.g., Ethernet switches). Each I/O node can incorporate multiple functions for use by the compute nodes 101-103 or other portions of the server system.

The I/O nodes 110-112 are coupled to the compute nodes 101-103 through a switch network 121. Each of the compute nodes 101-103 is coupled to the switch network 121 so that any one of the I/O nodes 110-112 can be switched to any one of the compute nodes 101-103. In one embodiment, the switch network 121 is a switch fabric using the PCI Express standard.

Control of each switch within the switch fabric 121 is accomplished by a management module 131 also referred to as a management node. Each management node 131 is comprised of a controller and memory that enables it to execute the control routines to control the switches.

The server system of FIG. 1 is for purposes of illustration only. An actual server system may be comprised of different quantities of compute nodes 101-103, switches 121, management nodes 131, and I/O nodes 110-112.

Each compute node 101-103 can be bound to one or more functions of an I/O node 110-112. The compute node 101-103 and the I/O node 110-112 work together to manage the memory bandwidth going through each connection. The management module 131 is responsible for allocating memory bandwidth for present and newly added resources (i.e., I/O node function) of each connection by configuring the memory space within each compute node and each I/O node.

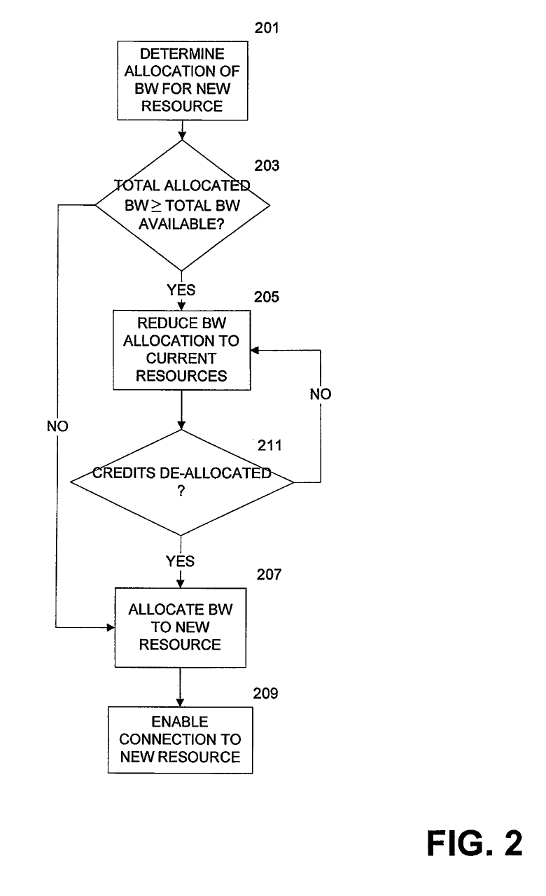

The following embodiments as illustrated in FIGS. 2-4 are dynamic flow control methods as executed by the management module. The flow control prevents receiver buffer overflow. The bound nodes share flow control information to prevent a device from transmitting a data packet that its bound node is unable to accept due to lack of available memory space. The present embodiments are dynamic in that the memory bandwidth can be adjusted without bringing down the link to reinitialize buffers and reset the nodes.

The present embodiments refer to adjusting the quality of service of a server system. This can include adjusting many aspects of a link including memory bandwidth. Memory bandwidth is the rate at which data can be read from or stored into a memory device and is typically measured in bits/second or bytes/second.

FIG. 2 illustrates a flow chart of one embodiment of a method for adding a new resource to a server system. Each host node can be bound to one or more resources of an I/O device. Once the binding is created, the host node and the I/O node work together to manage the memory bandwidth going through each connection as described subsequently.

To bind the new resource to the host node, the management module determines a memory bandwidth allocation for the new resource 201. The memory bandwidth allocation can be determined by user input to the server system or the management module determining that a particular resource requires a certain amount of memory bandwidth to operate properly.

A comparison is then done to determine if the total memory bandwidth allocated to all resources in the server system is greater than or equal to the total memory space available 203 in the system. If the total allocated memory bandwidth is less than the total memory space available in the system, extra memory bandwidth is allocated to the new resource 207. The allocated memory bandwidth may be in the compute node or the I/O node. The management module then enables a connection through the switching fabric to the new resource 209.

If the total allocated memory bandwidth is greater than or equal to the total memory space available 203, the management module reduces the memory bandwidth allocated to the other resources bound to the requesting host 205. The reduction in memory bandwidth is accomplished based on the priority of the other resources bound to the requesting host. When a new resource is added to the server system, it might have a different priority for operation than resources already bound to one or more host nodes. For example, if one of the other resources has a low priority and the new resource has a high priority, memory bandwidth is reallocated from the low priority resource and given to the new resource. A check is done to verify that the credits have been de-allocated 211. Once the credits have been de-allocated, this frees up memory space, allowing more memory bandwidth to be allocated by the management module to the new resource 207. The management module then enables the connection to the new resource 209.

A credit advertisement value scheme is used in dynamically adjusting the memory bandwidth used between the compute node and the I/O node. The credit advertisement is the memory space that the node sending the advertisement has physically available. The credit advertisement is based on a predetermined number of words of data equaling one credit (e.g., 16 bytes=1 credit). The compute node advertises to the I/O node the amount of memory space available in the compute node so that the I/O node cannot send more data than the compute node can physically store. This prevents an overflow condition between the compute node and the I/O node. The same advertisement applies in the other direction. The I/O node informs the compute node the size of its physical memory space by sending its advertisement to the compute node so that the compute node does not send too much data to the I/O node. In one embodiment, these advertisements are in the form of standard PCI Express TLPs using the Vendor Defined MsgD packet.

The described dynamic memory bandwidth allocation can be performed by the management module setting configuration registers in either the host node and/or the I/O node. The management module enters credit advertisement values for the adjustment and informs the relevant node whether to increase or decrease the credit allocation. In alternate embodiments, other server system elements might perform the memory bandwidth allocation.

After a resource is added to the system, the host node that is requesting the resource might need additional memory bandwidth to communicate with the new resource at the expense of memory bandwidth between the host node and other resources bound to the host node. In one embodiment, the management module is responsible for performing memory bandwidth allocation/adjustment between resource and host. The management module can adjust the memory bandwidth in both the upstream (i.e., from host to resource) and downstream (i.e., from resource to host) directions.

If additional memory bandwidth is needed in the upstream direction, the management module instructs the host node to dynamically allocate more memory bandwidth to the resource that is owned by that particular host node. If additional memory bandwidth is needed in the downstream direction, the management module instructs the I/O node to dynamically allocate more memory bandwidth to the host node that owns the resource. Memory bandwidth can be decreased in a similar manner. Memory bandwidth can be readjusted across multiple resources whenever new servers or I/O device functions are added or removed.

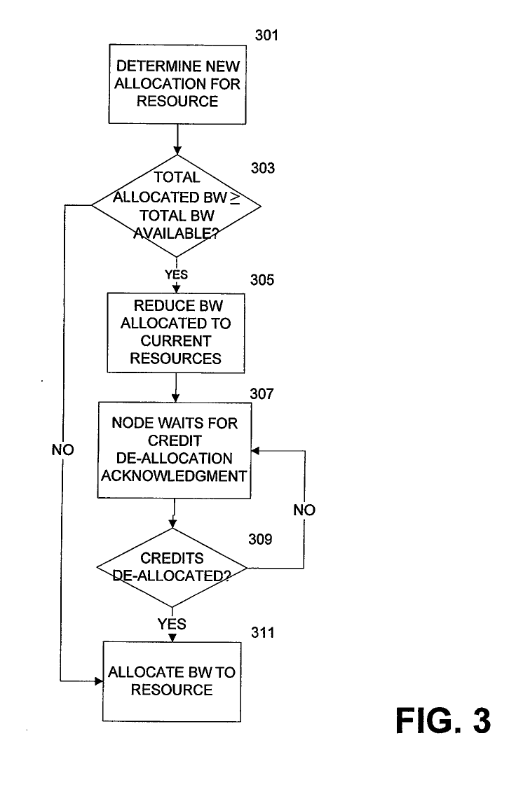

FIG. 3 illustrates a flow chart of one embodiment of a method for adding memory bandwidth for use by a resource. While the method is discussed in terms of allocating memory bandwidth to the resource that was just added, this method can also be used in allocating memory bandwidth to a resource that had already been bound to a host node.

The management module determines a memory bandwidth allocation for the new resource 301. This can be accomplished by some form of user input requesting additional memory bandwidth, the host node requesting additional memory bandwidth, or the I/O node requesting the additional memory bandwidth.

A comparison is then performed to determine if the total memory bandwidth that is allocated to all resources of the server system is greater than or equal to the total memory space available in the server system 303. If the total memory space available is greater than the total allocated memory bandwidth, the management module adjusts the memory bandwidth of current resources and allocates this memory bandwidth to the resource 311.

If the total allocated memory bandwidth is greater than or equal to the total memory space available, the management module reduces the memory bandwidth allocated to current resources 305. This can be accomplished by the management module configuring credit advertisement values for the I/O node and signaling a credit de-allocation to the I/O node to decrease the credit allocation 307. The management module waits for the credits to be de-allocated 309.

When the I/O node receives the request from the management module to de-allocate the credits for a particular connection, the I/O node sends an adjustment packet to announce the adjustment in credits available to its corresponding compute node. This packet contains the difference between the previous advertisement and the new advertisement value. It also contains a decrement bit for each credit field to signify a decrease in credits advertised. Since the I/O node is decreasing its credit advertisement, it will not adjust its credit limit counter.

The management module then can allocate memory bandwidth through the configuration registers in the host node and the I/O node for the new resource 311. The management module enters credit advertisement values for and informs the I/O node to increase the credit allocation. When the I/O node receives the request from the management module to allocate credits for a particular connection, the I/O node sends an adjustment packet to announce that the adjustment credits are available. This adjustment packet contains increment bits for each credit field to signify an increase in the credits advertised. The I/O node also increases its credit limit counter.

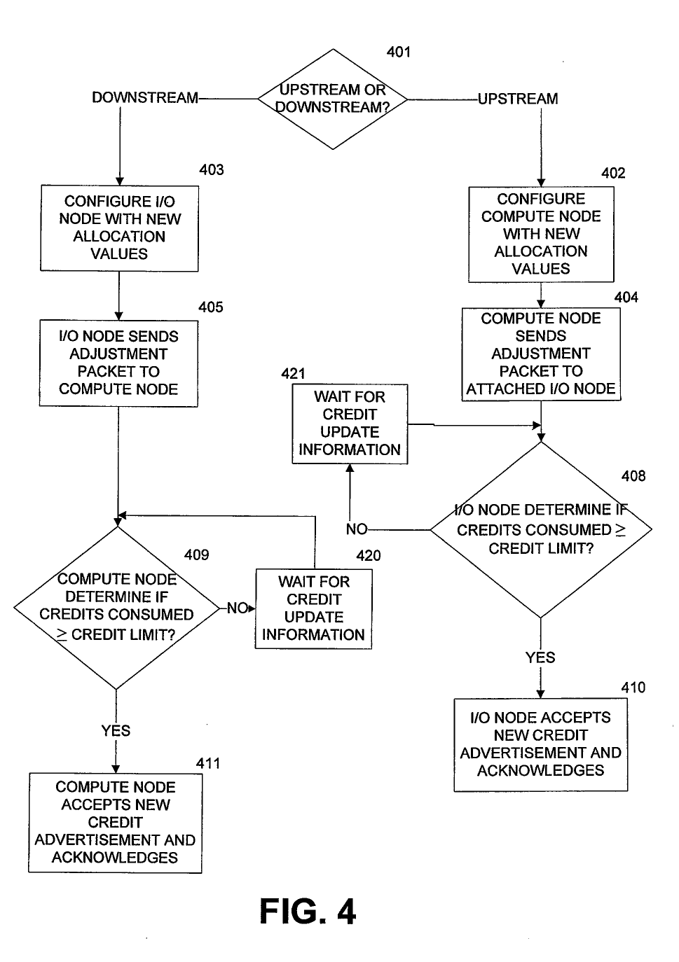

FIG. 4 illustrates a flow chart of one embodiment of a method for reducing memory bandwidth to a resource. The management module determines if the memory bandwidth is to be added in the downstream direction (i.e., resource to host) or the upstream direction (i.e., host to resource) 401.

If the memory bandwidth is added in the downstream direction, the management module configures the I/O node with new credit allocation values 403. The I/O node adjusts its credit limit counter and sends an adjustment packet to the bound compute node 405 to acknowledge the credit adjustment.

The compute node determines if it has enough credits available to decrease to the new credit value. The compute node checks the credits consumed to determine if they are greater than the credit limit 409. If the credit limit is greater than the credits consumed, the compute node waits for outstanding credit update information to be received 420 until the credit limit equals or is less than the credits consumed. If the credit consumed counter goes higher than the credit limit counter, the compute node blocks any new transactions from running and waits for outstanding credit updates to be received until the credit limit equals or is less than the credits consumed.

Once this has been satisfied, the compute node sends an acknowledgement packet to the connected I/O node to acknowledge the credit adjustment has been completed 411. When the compute node sends an adjustment packet signifying a decrement in credit value, it will release any credit updates that it is holding by sending these updates to its corresponding bound I/O device. If the updates are not enough to allow the I/O device to operate, credits will be released again when a timeout value is reached to reduce the chances of a stalled resource.

If the memory bandwidth is added in the upstream direction, the management module configures the compute node with the new allocation values 402. The I/O node sends an adjustment packet to the bound compute node 404. The I/O node then determines if it has enough credits available to decrease to the new credit value. As done in the downstream direction, if the credit limit is greater than the credits consumed 408, the compute node waits for outstanding credit update information to be received 421 until the credit limit equals the credits consumed. Once this has been satisfied, the I/O node accepts the new credit advertisement and sends and acknowledgement to the compute node 410 to acknowledge that the credit adjustment has been completed.

In summary, a method for dynamic quality of service adjustment that enables the increase or decrease of node buffer space in both the upstream and downstream directions, across a PCI Express fabric, without bringing down the link. Since, in a shared I/O environment, multiple servers may be sharing the same I/O function, the present embodiments enable a user to adjust the memory bandwidth for a particular host server to allow higher priority for a high memory bandwidth application while decreasing priority to another host server executing a lower priority application.

What is claimed is:

1. A method for dynamically adjusting quality of service for a link across a switching fabric, the method comprising:
determining total memory bandwidth allocation for a first resource of a plurality of resources;
determining if the total memory bandwidth allocation is greater than or equal to total memory bandwidth available for the resource;
reducing the memory bandwidth allocated to other resources of the plurality of resources if the total memory bandwidth allocation is greater than or equal to the total memory bandwidth available; and
allocating additional memory bandwidth to the first resource if the total memory bandwidth available is greater than the total memory bandwidth allocation.

2. The method of claim 1 and further including waiting for an acknowledgment of credit de-allocation after reducing the memory bandwidth allocated to other resources of the plurality of resources.

3. The method of claim 1 wherein the quality of service is adjusted without bringing down the link.

4. The method of claim 1 and further including adding the first resource to a server system.

5. The method of claim 4 wherein adding the first resource comprises enabling a link through the switching fabric to the first resource from a host node of the server system.

6. The method of claim 5 wherein reducing the memory bandwidth allocated to other resources comprises reducing memory bandwidth allocated to other resources that are bound to the host node bound to the first resource.

7. A method for dynamically adjusting quality of service for a link between a compute node and an I/O node across a switching fabric, the method comprising:
determining whether the quality of service adjustment is from the compute node to the I/O node or from the I/O node to the compute node;
when the quality of service adjustment is from the compute node to the I/O node, the adjustment comprises:
configuring the compute node with a first memory bandwidth allocation;
the compute node transmitting adjustment information to the I/O node;
determining if credits are available for the first memory bandwidth allocation; and
the I/O node accepting credit advertisement; and
when the quality of service adjustment is from the I/O node to the compute node, the adjustment comprises:
configuring the I/O node with a second memory bandwidth allocation;
the I/O node transmitting adjustment information to the compute node;
determining if credits are available for the second memory bandwidth allocation; and
the compute node accepting credit advertisement.

8. The method of claim 7 wherein the compute node is bound to the I/O node over the switching fabric.

9. The method of claim 7 wherein, in the I/O node to the compute node direction, the compute node transmitting an acknowledgement to the I/O node that the credit advertisement has been accepted.

10. The method of claim 7 wherein, in the compute node to the I/O node direction, the I/O node transmitting an acknowledgement to the compute node that the credit advertisement has been accepted.

11. The method of claim 8 wherein, in the compute node to the I/O node direction, if credits are not available for the first memory bandwidth allocation, the I/O node waiting for credit update information.

12. The method of claim 8 wherein, in the I/O node to the compute node direction, if credits are not available for the second memory bandwidth allocation, the compute node waiting for credit update information.

13. A server system comprising:
a host node configured to execute an operating system;
an I/O node comprising at least one function;
a switching fabric that couples the host node to the I/O node.
a management module, coupled to the host node and the I/O node through the switching fabric, the management module configured, without unlinking the host node and the I/O node, to determine total memory bandwidth allocation for the at least one function, determine if the total memory bandwidth allocation is greater than or equal to total memory bandwidth available for the at least one function, reduce the memory bandwidth allocated to other functions of the I/O node if the total memory bandwidth allocation is greater then or equal to the total memory bandwidth available, and allocate additional memory bandwidth to the at least one function if the total memory bandwidth available is greater than the total memory bandwidth allocation.

14. The server system of claim 12 wherein the switching fabric is a PCI Express fabric.

15. The server system of claim 13 wherein the host node comprises a compute node and the I/O node comprises a plurality of I/O functions configured to be bound to the compute node through the switching fabric.
